(19) United States
(12) Patent Application Publication
(10) Pub. No.: US 2015/0127293 A1
(43) Pub. Date: May 7, 2015

(54) TIME OF DEATH PROBE AND RECORDER

(71) Applicants: EUGENE TERRY TATUM, BOWLING GREEN, KY (US); Stacy S. Wilson, Bowling Green, KY (US); Kyle Moss, Bowling Green, KY (US)

(72) Inventors: EUGENE TERRY TATUM, BOWLING GREEN, KY (US); Stacy S. Wilson, Bowling Green, KY (US); Kyle Moss, Bowling Green, KY (US)

(21) Appl. No.: 14/478,268

(22) Filed: Sep. 5, 2014

Related U.S. Application Data
(60) Provisional application No. 61/875,611, filed on Sep. 9, 2013.

(51) Int. Cl. G01K 13/00; G01J 5/02

(52) U.S. Cl. CPC G01K 13/004; G01J 5/025; G01J 5/028
USPC 702/131

(57) ABSTRACT

The present invention is comprised generally of a core body thermometer probe; a means to record temperature data from probe; a timing mechanism; a means to record time data from timing mechanism; a means to correlate recorded time and temperature data; a non-volatile memory unit to store correlated time and temperature data; and a power source and a method of use to determine time of death of a biological organism.

### RELATED APPLICATIONS

This application claims priority to U.S. Provisional Application No. 61/875,616 filed Sep. 9, 2013. The entire contents of the above application are hereby incorporated by reference as though fully set forth herein.

### BACKGROUND

The present invention is within the field of forensic medicine. More particularly, the present invention relates to improvements for determining time of death in forensic medicine. It is well known that determination of time of death can be crucially important in death scene investigations. The coroner or medical examiner, in accurately determining time of death, often plays a major role in ruling in or out certain homicide suspects, and even determining manner of death (accident, suicide or homicide, for example). Unfortunately, the current state of the art in determining time of death is such that estimates can vary widely, depending upon the skill and experience of the medical examiner, and the relatively subjective evaluation of such things as degree of rigor mortis, lividity, stomach contents, etc. Even in the best of hands, an estimated time of death range is usually no better than plus or minus several hours, especially when no reliable witnesses are available. What is greatly needed in this field is a scientific device, which provides a multitude of objective data points, so that much greater accuracy can be obtained in determining time of death, especially in cases where death was apparently recent (within the previous 24 hours) and without any witnesses. It is also an object of the present invention to provide for a device that can be used at the death scene investigation so that a rapid determination of “working time of death” can be provided to homicide detectives and other investigators, before the autopsy can be conducted, in order to expedite their work.

The present invention is a time of death probe and recorder, known hereafter as “TDPR.”

Before describing the details of this invention, it is first useful to briefly review the scientific principle upon which the invention is based. In 1701 Sir Isaac Newton defined the Law of Cooling, which is quoted by Clifford Pickover's book entitled “Archimedes to Hawking—Laws of Science and the Great Minds Behind Them” (Oxford University Press, 2008, page 104):
“According to Newton's Law of Cooling, the rate of heat loss of a body is proportional to the difference in temperature between the body and its surroundings. Today we often write this law as T(t)=Tₑₙᵥ+[T₀−Tₑₙᵥ]e^{-kt}, where T is temperature, t is time, Tₑₙᵥ is the temperature of the environment, T(0) is the initial temperature of the object, and k is a positive constant. For example, imagine that you have a pot of boiling tomato soup and place it in a sink of cold water kept at a constant 4° C. by running water through the sink. You stir the soup as it cools. The rate of change of the temperature of the soup is governed by T(0)=100 and Tₑₙᵥ=4, so T(t)=4+96e^{-kt}. If we had an additional measurement, such as the temperature of the soup after 5 minutes, we could calculate the value of k and then have a complete equation that specifies the temperature of the soup at any time t. My teachers once explained to me that we could use Newton's Law of Cooling to find the time of death for a corpse discovered in a motel room if we know the temperature of the room, which is assumed to be constant. For example, you are called to a crime scene at the edge of town, and you find a woman's body lying on the carpet of some rundown motel room. Her corpse is at a temperature of 80° F. The temperature of the room is a cool 60° F. An hour later, the temperature of the corpse drops to 75° F. This is all the information you need to find the approximate time of death, if you assume she had a normal body temperature of 98.6° F. while alive. The time of death will only be approximate. Newton's law of cooling assumes a uniform temperature of the cooling body. However, in reality, a human body is not uniformly warm, and the skin is certainly cooler than the internal organs. Nevertheless, Newton's Law of Cooling gives a good approximation of the time of death for an individual.”

The TDPR of the present invention makes use of Newton's Law of Cooling and provides a solution to the non-uniformity of body temperature issue raised by the preceding paragraph, by focusing on time dependent changes in core body temperature. It is well known that the skin temperature of a human body can vary widely from one location on the body to another, simply by differences in the body's immediate environment (ambient heat and light exposure, temperature conducting surfaces, different articles of clothing, etc.) and body position relative to these environmental variables. However, it is also well known that core body temperature shows little variation from one core body site (liver, heart, brain, middle ear, etc.) to another while the core body temperature gradually (over an extended period of time) moves towards equilibration with the surrounding environmental temperature.

The present invention continually or intermittently measures and records core body temperature and time. This information can be plotted on a graph and the time of death (“time zero”) may be accurately extrapolated using the above equation from Newton's Law of Cooling, or a modern facsimile thermodynamic equation. Naturally, the degree of accuracy will also be improved by the greater the temperature difference between the core body temperature and the environmental temperature ([T₀−Tₑₙᵥ] in the Law of Cooling equation above). Note that Tₒ is “initial measured temperature of object” and not the same as T(0), “the temperature of the object at time zero” in the Law of Cooling equation. Obviously, once the core body temperature has completely equilibrated with the environmental temperature, the TDPR of the present invention would not be useful. However, in the common situations where there is a significant temperature difference between the core body temperature and the environmental temperature, and where it can also be assumed that the environmental temperature conditions have not significantly changed since the time of death, the TDPR of the present invention can be extremely helpful in accurately determining time of death. The accuracy of this extrapolation is at a premium if one can also assume that the deceased had a normal body temperature (98.6° F. plus or minus a few tenths of a degree) at the time of death, but is still high for situations in which the deceased was only mildly febrile or mildly hypothermic at the time of death.

Once multiple core body temperature and time measurements are recorded by the TDPR over a sufficient time interval, this information is communicated to, and analyzed by a software application on any number of digital computer system devices, such as smart phones, tablets, laptops, desktops, servers, etc.). Various embodiments of this present invention incorporate such means of digital computer system device communication.

### BRIEF DESCRIPTION

The TDPR of the present invention is comprised generally of a core body thermometer probe; a means to record temperature data from probe; a timing mechanism; a means to record time data from timing mechanism; a means to correlate recorded time and temperature data; a non-volatile memory unit to store correlated time and temperature data; and a power source.

The present invention may further comprise a wireless device to transmit correlated time and temperature data to any digital computer system device, such as a smart phone, tablet, laptop, desktop, server, etc.

The present invention may have a display unit to indicate the status of the device. The present invention may further comprise a software application wherein the software application analyzes the correlated time and temperature data using a thermodynamic equation that extrapolates the time of death.

The means to record temperature data from probe may be comprised of a microprocessor to record digital or analog electronic signals from the probe. The timing mechanism may be a digital or analog real-time clock. The means to record time data from timing mechanism may be comprised of a microprocessor to record digital or analog electronic signals from the timing mechanism. The non-volatile memory may be a microprocessor, a flash drive, secure digital card, or other similarly removable memory card or disk or combinations thereof. The power source may be a battery, an electrical outlet with voltage regulation or combinations thereof. Preferably, the core body thermometer probe is comprised of at least one infrared sensor.

### BRIEF DESCRIPTION OF THE DRAWINGS

FIG. 1A is a schematic representation of the basic elements of the TDPR of the present invention.

FIG. 1B is a schematic representation of the basic elements of the TDPR of the present invention.

FIG. 2 is a block diagram representation of the basic electronic elements of the TDPR of the present invention.

FIG. 3 shows the TDPR of the present invention inserted into the body (in this case, the external auditory canal) during the temperature/time recording phase.

FIG. 4 shows an extrapolation graph from recorded data points using the law of cooling equation showing a “time zero.”

### DETAILED DESCRIPTION

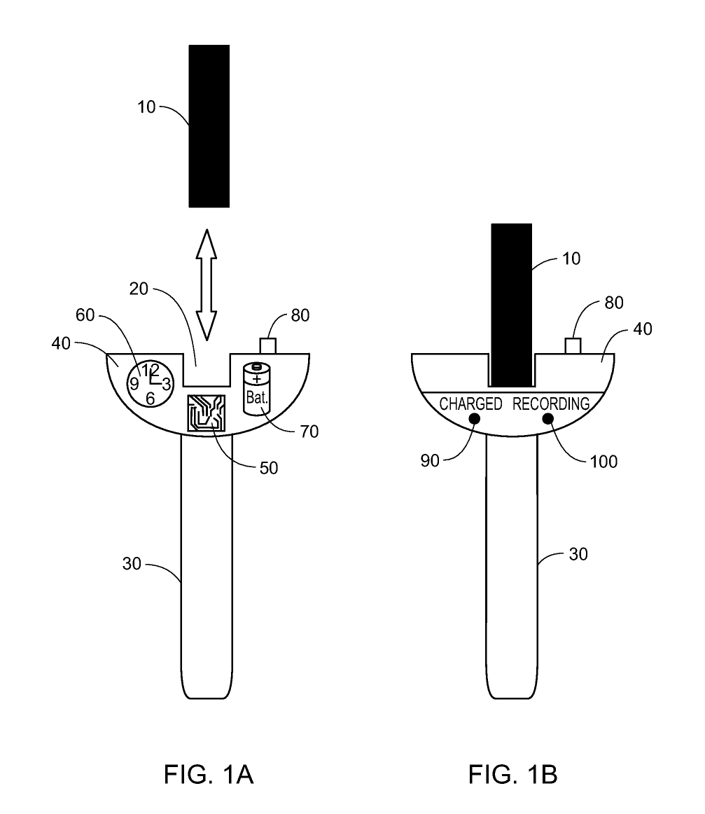

Turning to FIGS. 1A and 1B, the non-volatile memory storage device 10 (here represented as a SD card) is shown before (FIG. 1A) and after (FIG. 1B) insertion into the memory storage device port 20 of the housing 40. The temperature probe portion 30 is shown projecting from the housing 40 and, in this particular example, on the side opposite to the memory storage device port 20. This arrangement allows for easy access to the memory storage device before, during and after the temperature/time recording phase. The TDPR houses a circuit board (not shown) which electronically links the microprocessor unit 50, real-time clock 60, non-volatile memory storage 10, and ancillary electronics [including an optional wireless transceiver (not shown)]. The TDPR has a push button 80 incorporated to start and stop the recording of data. A light emitting diode (LED) display 90 and 100 is used to indicate the status of the device (ready/charged 90, recording 100, etc.). After the data is recorded, the user retrieves the data from the non-volatile memory storage device 10 using a software application developed specifically for that purpose. The data can either be streamed to a digital computer system device, such as a smart phone, tablet, laptop, desktop, or server, using the (optional) wireless transceiver or downloaded directly from a non-volatile removable memory storage device 10 such as a SD card or flash drive. The infrared (IR) temperature sensor is encapsulated within the probe portion 30 (of the housing 40) that is inserted into the ear canal.

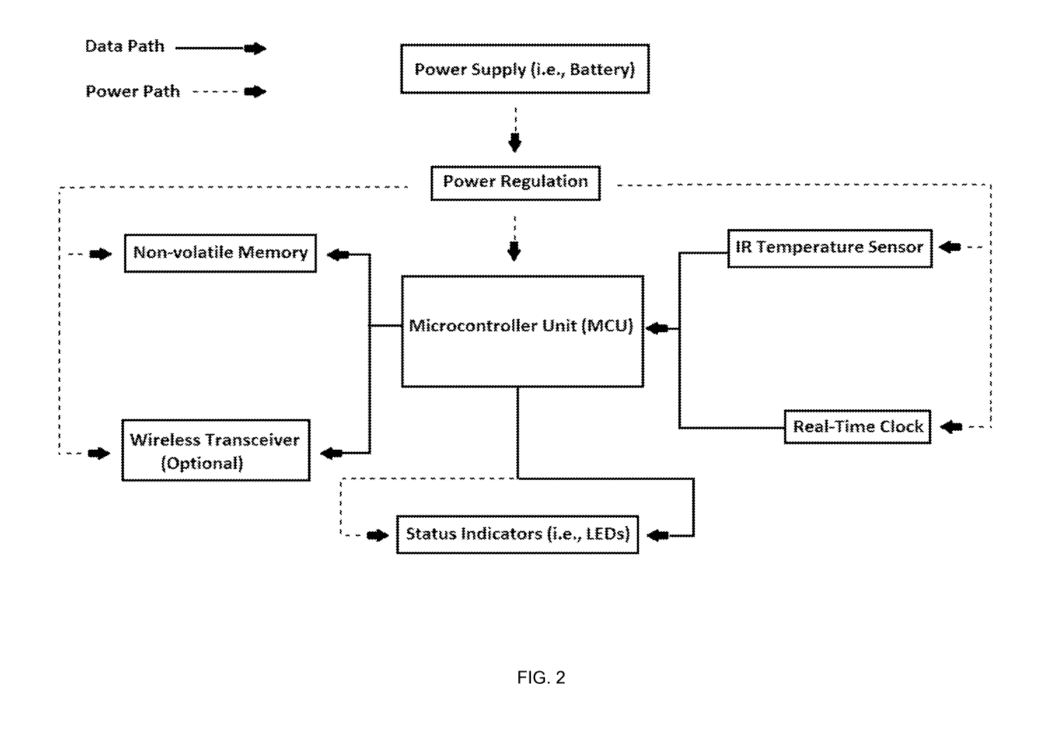

Turning to FIG. 2, power is provided to all necessary components through a voltage regulation circuit from a power source within the device (i.e., a battery) or from an electrical outlet with power cord. The microcontroller unit (MCU) combines data received over a communication channel from the temperature sensor and real-time clock. The microcontroller can receive data as a digital or analog signal. The microcontroller monitors the voltage level of the power provided as well as the current state of the system and outputs digital and/or analog data to a status indicator (i.e., LED) to indicate the current operating status of the device. Temperature and time data collected by the microcontroller is correlated and then transmitted for storage to non-volatile memory (i.e., Secure Digital (SD) card, flash drive, etc.). This data can also be transmitted using various radio frequency (RF) methodologies (i.e., Bluetooth, WiFi, etc.) in near-real time to a smart phone, tablet, laptop, desktop, or other digital computer platform for processing.

As an optional accessory electronic element, a wireless transceiver may also be included, and controlled by the microprocessor, for streaming data during or after the recording phase. The present invention also includes a software application which analyzes the recorded temperature/time data using the above equation for Newton's Law of Cooling, or a modern facsimile thermodynamic equation, to extrapolate the time of death (“time zero”). For example, the thermodynamic equation T(t)=Tₑₙᵥ+[T₀−Tₑₙᵥ]e^{-kt}, may be used, where T is temperature, t is time, Tₑₙᵥ is the temperature of the environment, T₀ is the initial measured temperature of the biological organism, and k is a positive constant, and wherein said equation is used to extrapolate the time (“time zero”) when the organism was last at its normal core body temperature, defined as T(0).

Although any temperature probe 30 which can be inserted within the body to record core body temperature can be considered within the scope of the present invention, the best use embodiment of the TDPR core body thermometer is believed to be an infrared (IR) ear canal thermometer. Such devices already have the capability to quickly, easily, and accurately measure core body temperature. For instance, in pediatric medicine, small, non-invasive IR ear thermometers are used to measure the temperature of the tympanic membrane (“ear drum”). Infrared sensors record temperature and convert the temperature to an analog signal.

Turning back to FIG. 1, a real-time clock 60 is incorporated into the present invention for accuracy. The clock 60 is used to time stamp the temperature data recorded. The time and temperature data is stored in non-volatile memory 10.

The microprocessor 50 records electronic signals (in either digital or analog form) from the above thermometer probe 30 and real-time clock 60 in non-volatile memory 10. An excellent example of such a memory device in current use is a SD card. A flash drive is another excellent example. A small coin battery is used as the power supply, such as a battery used in watches. However, it is contemplated that an electrical outlet and power cord may also be used. A push button 80 is used to start and stop the recording of the TDPR. A LED display shown as 90 and 100 together is used to indicate the status of the device.

Turning to FIG. 2, power is provided to all necessary components through a voltage regulation circuit from a power source connected to the device (i.e., a battery). The microcontroller unit (MCU) combines data received over a communication channel from the temperature sensor and real-time clock. The microcontroller can receive data as a digital or analog signal. The microcontroller monitors the voltage level of the power provided as well as the current state of the system and outputs digital and/or analog data to a status indicator (i.e., LED) to indicate the current operating status of the device. Temperature and time data collected by the microcontroller is correlated and then transmitted for storage to non-volatile memory (i.e., SD card, flash drive, etc.). This data can also be transmitted using various RF methodologies (i.e., Bluetooth, WiFi, etc.) in near-real time to a smart phone, tablet, laptop, desktop, server, or other digital computer device platform for processing.

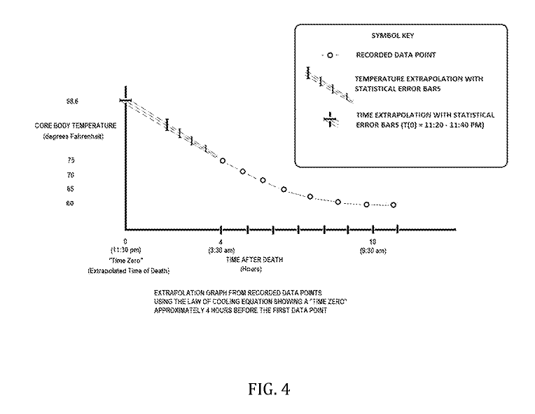

A software application analyzes the time and temperature data to create a graph displaying the change in core body temperature of the deceased as a function of time. The program utilizes Newton's Law of Cooling equation given above, or a modern facsimile thermodynamic equation, to extrapolate the temperature/time graph back to time zero, which is operationally defined as the point where the temperature/time graph intersects the temperature ordinate axis at 98.6° F. or 36.9° C. Statistical error bars are also plotted on the graph according to accepted rules of statistical analysis. FIG. 4 shows an example of a Temperature vs Time graph of the temperature/time data recorded by the TDPR. The estimated time range for time of death (“time zero”), represented by the horizontal line with error bars at 98.6 degrees Fahrenheit, is extrapolated from the recorded temperature/time data points, utilizing the Law of Cooling equation, or a modern facsimile thermodynamic equation, by the software application installed on a smart phone, tablet, laptop, desktop, or server (not shown). FIG. 4 shows one such example of a regression analysis of plotted data points first measured four hours following the time of death. In this example, the first data point recorded on the graph at time 3:30 am, and the subsequent data points, indicate a time of death for the deceased at approximately 11:30 pm, with a statistical range of error of plus or minus 10 minutes, as represented by the horizontal line with error bars at 98.6 degrees Fahrenheit. In other words, a confident and reasonably narrow range for time of death (11:20 pm to 11:40 pm) can be estimated. This degree of accuracy for time of death determination has never before been available in forensic medicine.

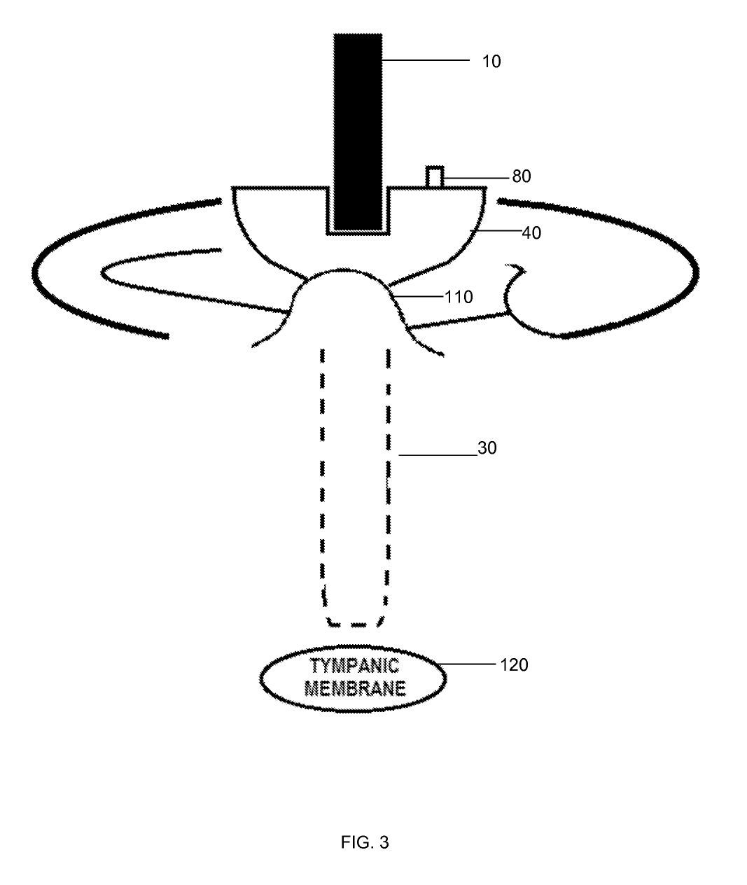

The following is a brief description of the best use of the preferred embodiment of this invention in the field of forensic medicine. Turning to FIG. 3, the crime lab technician or coroner, upon arriving at the scene of a death investigation, places the temperature probe end 30 of this device into the most easily accessible ear canal 110 of the deceased and begins recording core temperature/time data by pushing the button 80 on the housing apparatus 40. This activates the device and begins a data recording session. At the same time, the crime scene technician records the time of day in their notes as to when temperature and time data recording began. During the recording session, efforts are made to leave the body in roughly the same position within the environment in which it was found. The crime scene technician also records the environmental temperature in which the body was found during the recording session. Finally, the crime scene technician records the time of day at the end of the recording session and pushes the button 80 to stop recording. The technician then removes the device and labels the SD card (or alternative non-volatile memory storage device) 10 with the forensic case number.

Depending upon which embodiment of this invention is used, the data is either streamed to a digital computer system device for real-time analysis during the recording session or analyzed soon thereafter from non-volatile memory. The data is analyzed by software application installed on a smart phone, tablet, laptop or other portable digital computer either at the crime scene or back at the forensic laboratory. In this way, a “working time of death” can be determined at the end of the recording session, pending collection of all other forensic evidence for the coroner to establish an “official time of death.” This information can be of great use to homicide detectives in the field immediately after the data recording session, as opposed to waiting for the preliminary autopsy results, which may come a day or more later.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the system (and components of the individual operating components of the system) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A device for determining the time of death of a biological organism comprising:
i. core body thermometer probe;
ii. means to record temperature data from probe;
iii. a timing mechanism;
iv. means to record time data from timing mechanism;
v. means to correlate recorded time and temperature data;
vi. non-volatile memory unit to store correlated time and temperature data; and
vii. a power source.

2. The device of claim 1 further comprising a wireless device and digital computer system device to transmit correlated time and temperature data to the digital computer system device.

3. The device of claim 1 further comprising a removable memory storage device and digital computer system device wherein the correlated time and temperature data is directly downloaded from the memory storage device to the digital computer system device.

4. The device of claim 1 further comprising a display unit to indicate the status of the device.

5. The device of claim 1 further comprising a software application wherein the software application analyzes the correlated time and temperature data using a thermodynamic equation that extrapolates the time of death.

6. The device of claim 5 wherein the thermodynamic equation is T(t)=Tₑₙᵥ+[T₀−Tₑₙᵥ]e^{-kt}, where T is temperature, t is time, Tₑₙᵥ is the temperature of the environment, T₀ is the initial measured temperature of the biological organism, and k is a positive constant, and wherein said equation is used to extrapolate the time (“time zero”) when the organism was last at its normal core body temperature, defined as T(0).

7. The device of claim 1 wherein the means to record temperature data from probe is comprised of a microprocessor to record digital or analog electronic signals from the probe.

8. The device of claim 1 wherein the timing mechanism is a digital or analog real-time clock.

9. The device of claim 1 wherein the means to record time data from timing mechanism is comprised of a microprocessor to record digital or analog electronic signals from the timing mechanism.

10. The device of claim 1 wherein the non-volatile memory is selected from the group comprising a microprocessor, a flash drive, secure digital card, or other similarly removable memory card or disk or combinations thereof.

11. The device of claim 1 wherein the power source is selected from the group comprising a battery, an electrical outlet with voltage regulation or combinations thereof.

12. The device of claim 1 wherein the core body thermometer probe is comprised of at least one infrared sensor.

13. The device of claim 1 wherein the biological organism is human.

14. The method for determining the time of death of a biological organism comprising:
i. measuring the environmental temperature around the biological organism;
ii. measuring and recording post mortem core body temperature at different time intervals post mortem using a device comprising:
a. core body thermometer probe;
b. means to record temperature data from probe;
c. a timing mechanism;
d. means to record time data from timing mechanism;
e. means to correlate recorded time and temperature data;
f. non-volatile memory unit to store correlated time and temperature data; and
g. a power source
iii. correlating time and temperature recordings with a software application using a thermodynamic equation that extrapolates the time of death.

15. The method of claim 14 wherein the thermodynamic equation is T(t)=Tₑₙᵥ+[T₀−Tₑₙᵥ]e^{-kt}, where T is temperature, t is time, Tₑₙᵥ is the temperature of the environment, T₀ is the initial measured temperature of the biological organism, and k is a positive constant, and wherein said equation is used to extrapolate the time (“time zero”) when the organism was last at its normal core body temperature, defined as T(0).

16. The method of claim 14 wherein the device further comprises a wireless device and digital computer system device to transmit correlated time and temperature data to the digital computer system device.

17. The method of claim 14 wherein the device further comprises a removable memory storage device and digital computer system device wherein the correlated time and temperature data is directly downloaded from the memory storage device to the digital computer system device.

18. The method of claim 14 wherein the device further comprises a display unit to indicate the status of the device.

19. A method for determining the time of death of a biological organism comprising:
i. measuring the environmental temperature around the biological organism;
ii. measuring and recording post mortem core body temperature at different time intervals post mortem;
iii. correlating time and temperature recordings with a software application using a thermodynamic equation that extrapolates the time of death.

20. The method of claim 19 wherein the thermodynamic equation is T(t)=Tₑₙᵥ+[T₀−Tₑₙᵥ]e^{-kt}, where T is temperature, t is time, T, is the temperature of the environment, T₀ is the initial measured temperature of the biological organism, and k is a positive constant, and wherein said equation is used to extrapolate the time (“time zero”) when the organism was last at its normal core body temperature, defined as T(0).
